(19) United States
(12) Patent Application Publication
(10) Pub. No.: US 2014/0279417 A1
(43) Pub. Date: Sep. 18, 2014

(54) System And Methods For Funds Transfer And Receipt

(71) Applicants: Rahier Rahman, Chicago, IL (US); Thomas Buchar, Chicago, IL (US); Brent Allen, Chicago, IL (US); Andrew McCarter, Chicago, IL (US); Greg Bauer, Chicago, IL (US)

(72) Inventors: Rahier Rahman, Chicago, IL (US); Thomas Buchar, Chicago, IL (US); Brent Allen, Chicago, IL (US); Andrew McCarter, Chicago, IL (US); Greg Bauer, Chicago, IL (US)

(21) Appl. No.: 13/841,219

(22) Filed: Mar. 15, 2013

(51) Int. Cl. G06Q 20/10

(52) U.S. Cl. CPC G06Q 20/10
USPC 705/39

(57) ABSTRACT

A system and method for collaborative peer-to-peer fund transfer that allows the transfer of funds without requiring a bank account. The present invention uses existing infrastructure to allow senders to initiate fund transfer to designated recipients. The system receives a transfer request from a sender via an SMS Gateway, retail kiosk, web interface, or bank transfer, and processes a transaction. The system communicates a unique code for confirmation to the designated recipient, who can use the unique code to redeem the transferred funds. The transferred funds are then associated with a prepaid card, debit card, or gift card, or disbursed in cash form.

The present invention is related to, and claims priority from, U.S. Prov. App. No. 61/695,479, filed on Aug. 31, 2012. U.S. Prov. App. No. 61/695,479 is hereby incorporated by reference in its entirety.

### BACKGROUND OF THE INVENTION

1. Field of the Invention

The present invention relates generally to systems and methods for transferring and receiving funds, and more particularly to a collaborative peer-to-peer system and method for sending and receiving funds between a user and a designated recipient via SMS transmission or through a web interface.

2. Description of the Prior Art

The prior art includes prepaid debit cards which may be used by individuals who do may have a bank account or credit card. These debit cards may be issued by Visa or MasterCard, for example, and in many instances the prepaid debit card holder may reload the debit card at a point of sale terminal, such as a cash register at a retail location.

But the prior art does not disclose a system and method that allows users of prepaid debit cards or gift cards to transfer funds among each other, or to a designated recipient. Therefore, it would be extremely advantageous to have a system and method for transferring funds that can be integrated with existing infrastructure and allows users of prepaid cards and/or gift cards to transfer funds between each other, or to send funds to a designated recipient, where such peer-to-peer transfers may be initiated, for example, via a text message, web interface, or retail point-of-sale terminal.

### SUMMARY OF THE INVENTION

The present invention relates to a collaborative peer-to-peer system and method for transferring funds among registered users, or from one user to a designated recipient. To do this, the system and method seamlessly integrates previously closed-loop networks used for activating prepaid gift cards and creates an open-loop network allowing funds to be transferred both intra- and inter-network. The system and method include a SMS Gateway, a middleware layer, a network administrator layer, a processor, and a funding source. These components may be easily integrated with existing retail point-of-sale-activation-networks (“POSA Networks”) (i.e. point-of-sale terminals at retail locations) and can therefore use existing infrastructure to provide seamless peer-to-peer transfer and receipt of funds. Users may, but preferably should, register with the system to initiate a transfer request, which can be initiated through a communication portal. It is contemplated that the communication portal may be a retail kiosk, a web interface, or a SMS Gateway. When sending a transfer request to the communication portal, the sender may include an account identifier, wherein an account identifier is considered to be any piece of information that the system has associated with the user's account. The recipient may, but preferable should, also register with the system in order to receive the funds. The system and method also include an optional PIN code which can be transmitted by a sender directly to the recipient, and the recipient may be required to enter that PIN code into the system before funds are released to the recipient.

### DESCRIPTION OF THE FIGURES

Attention is now directed to several drawings that illustrate features of the present invention:

FIG. 1. is an exemplary configuration of the system.

FIG. 2 is one embodiment of the records that may be stored in the memory at the middleware.

FIG. 3A is an exemplary template of a transfer request. FIG. 3B is an example of a completed transfer request.

FIG. 4 is a flow chart depicting funds transfer through a mobile device to an active or activated transaction card.

FIG. 5 is a process chart depicting the funds transfer through a mobile device to an active or activated transaction card, as described in FIG. 4.

FIG. 6 is a flow chart depicting funds transfer through a website to an active or activated transaction card.

FIG. 7 is a process chart depicting the funds transfer through a website to an active or activated transaction card, as shown in FIG. 6.

FIG. 8 is a flow chart depicting funds transfer from a first user through a retail location to a second user through a retail location.

FIG. 9 is a process chart depicting the funds transfer from a first user through a retail location to a second user through a retail location, as shown in FIG. 8.

These drawings and illustrations have been presented to aid in understanding the present invention. The scope of the present invention is not limited to what is shown in the figures.

### DETAILED DESCRIPTION OF THE INVENTION

Examples of the systems and methods for transferring and receiving funds are shown in FIGS. 1 through 9. FIG. 1, for example, shows one embodiment of a system having a user, a retail kiosk 100, a SMS Gateway 120, middleware 140, a network administrator 160, a processor 180, and a funding source 190. In the figures, the middleware 140 is also referred to as “PDMS.”

The middleware 140 comprises a server which has a processor and memory, and includes software further described herein. The memory of the middleware 140 includes records identifying users of the system, including information such as their names, account number(s), telephone number(s), email address, etc. FIG. 2 describes an example of such records. In the example of FIG. 2, the records contain a user name, mobile number, account number, and email address. Therefore, if a user is identified by user name only, the middleware can still determine the user's mobile number by retrieving the associated mobile number from memory. Each piece of information associated with a user may be used as an account identifier for that user's account.

The middleware 140 also contains at least one communication port, such as a wireless or Ethernet connection, that communicates with the SMS Gateway 120 and the network administrator 160. Such communication may occur over the interne, a private network, or by way of any other means for electronic communication. Collectively, these are referred to as communication channel 101.

The SMS Gateway 120 is a telecommunications network device for sending and receiving SMS (short message service) transmission. The SMS Gateway 120 is capable of sending and receiving SMS transmissions to and from a user's mobile device. When the SMS Gateway 120 receives a SMS transmission from a user, it recognizes the mobile number of the user's device. Because the SMS Gateway 120 is connected via a communication channel 101 to the middleware 140, it can also route SMS messages to and from the middleware 140. Users of the system can therefore communicate with the middleware 140 via SMS message. In some embodiments, the SMS Gateway 120 may automatically include the user's mobile number when it routes a SMS message from a user to the middleware 140.

The network administrator 160 includes a server and software for receiving, storing, formatting, and sending messages between the middleware 140 and a processor 180. The processor 180 includes a server and software for eceiving, storing, formatting, and sending messages. As seen in FIG. 1, in one embodiment the processor 180 is in communication with the funding source 190. The funding source 190 comprises a server and software for receiving, storing, formatting, and sending messages. A memory at the funding source 190 stores records identifying users of the system, including information such as their names, account number(s), telephone number(s), email address, etc. The funding source 190 also maintains account records that indicate the balance of funds available to each user. The funding source 190 may act as its own clearinghouse. In some embodiments, the records of the funding source 190's may also include account information for a user's bank account or credit card, thereby allowing a user to transfer funds from his or her bank account/credit card directly to another user's prepaid debit card.

The retail kiosk 100, herein also referred to as a retail location, retail kiosk, or retail point-of-sale terminal, may include existing retail infrastructure that is already used for processing credit, debit, and/or gift card transactions. In some instances, such infrastructure is referred to as a point-of-sale-activation-network (“POSA Network”). The retail kiosk 100 could also be an ATM machine, or equivalent thereto in function, thus allowing a recipient to receive a prepaid card or cash from the kiosk 100. These kiosks are presently capable of reading information from credit cards and/or debit cards, gift cards, or prepaid cards using, for example, a magnetic stripe reader, or near field communication technology. Although some embodiments herein are described as using credit/debit cards, prepaid cards, or gift cards, it is understood that these cards are similar in function and a person having ordinary skill in the art would know how to interchange them. Moreover, kiosks are also capable of communicating with financial institutions over a communication channel such as the interne or a private network. In one embodiment, users may use retail kiosk(s) 100 to initiate a transfer of funds from one user to another user. One benefit of using retail kiosks is that they already exist in many retail locations, and therefore no new infrastructure is required. However, as explained further herein, transfers may also be initiated by SMS transmission (received by a SMS Gateway 120), through a retail kiosk 100, or through a web portal such as a website or mobile phone application. Collectively, these may be referred to as communication portal(s).

These components may have various configurations, as further described herein. Together, the system enables collaborative peer-to-peer fund transfers between registered users. Registered users receive a debit card, and the debit card's balance (i.e. the funds available) is stored at the funding source 190. The registered users can transfer funds between cards. A sender may initiate a transfer of funds to a recipient via a SMS message sent to the SMS Gateway 120.

Where the sender has designated a recipient who is not a registered user, the system allows the designated recipient to register. Alternatively, the designated recipient may choose not to register, and instead receive the transferred funds on a gift card, or in the form of cash.

It is also contemplated that the sender may initiate a transaction via a website interface, or by using the sender's debit/prepaid card at an existing retail location. The system transfers the funds to the recipient's prepaid card or gift card. In some embodiments, if the recipient is not a registered user, the funds may be held until the recipient registers a debit/prepaid card. An unregistered user may register at a retail location, or through a web interface. Once registered, the system may release the funds onto the recipient's debit/prepaid card.

In one embodiment, a user requesting a transfer of funds to a recipient can send a transfer request 300 via a SMS message to the middleware 140, through the SMS Gateway 120. FIGS. 4-7 show schematics and flow charts describing a transaction initiated by a transfer request 300 sent through a SMS Gateway 120. More specifically, FIGS. 4 & 5 relate to a scenario in which a transfer request 300 is initiated via SMS message, and include an option for unregistered recipients to register via a retail kiosk 100. FIGS. 6 & 7 also relate to an embodiment in which a transfer request 300 is initiated via SMS message, but instead show an option for unregistered recipients to register via a web interface (also referred to as the “POMS Website”).

The format of the transfer request 300 may vary, but an example of the format of a transfer request 300 is shown in FIGS. 3A & 3B. More specifically, FIG. 3A shows a template for a transfer request 300, and FIG. 3B shows a completed example of a transfer request 301 that may be transmitted by the sender via SMS message to the SMS Gateway 120.

It is contemplated that a transfer request 300 must contain at least an amount to transfer, and information identifying the recipient. Preferably, the recipient is identified by the recipient's mobile number. As further described below, the middleware 140 communicates with the recipient, and identifying the recipient by mobile number allows the middleware 140 to easily communicate with the recipient through the SMS Gateway 120. Alternatively, the recipient may be identified by name, email address, account number, or other identifying information. In such an embodiment, the middleware 140 has a memory for retrieving a mobile number (or alternate contact information) corresponding to the recipient's identifying information. For example, the memory may contain a record storing a user's name, account number, mobile number, and email address. When the user is identified by name, the record in memory is retrieved and the user's corresponding mobile number determined.

Additionally, the transfer request 300 could include information about the sender, such as the mobile number of the sender who originated the transfer request 300. A sender may include the mobile number in a transfer request 300, or the mobile number can be automatically attached to the transfer request 300 by the SMS Gateway 120 when the SMS Gateway 120 routes the request to the middleware 140. The SMS Gateway 120 necessarily knows the mobile number from which the transfer request 300 originates.

In an embodiment where the sender has multiple accounts, or has linked bank account/credit card information to the middleware 140 account, the sender must also specify from which account the sender wishes to deduct the transferred funds. A sender may wish to convey to the middleware the sender's bank account information, or other information for enabling check deposit or direct deposit. Such information is stored in the memory of the middleware 140 and associated with the sender's account information. Doing so allows the sender to use alternative sources of funds for transfer. Thus, a sender is not necessarily limited to transferring funds from a prepaid card, but may instead transfer funds from a bank account, or by direct/check deposit.

Using the sender's mobile number, the middleware 140 can validate whether the sender is a registered user of the system. This validation may be performed by comparing the sender's phone number to the phone numbers of registered users. If the sender is instead identified by other identifying information, then the middleware 140 uses that identifying information to perform the comparison. For example, in another embodiment, the sender may be required to include his or her name, account number, or any other piece of identifying information in the transfer request 300 sent via SMS transmission to the middleware 140. The middleware 140 can then use that other information to validate whether the sender is a registered user.

If the middleware 140 determines that the sender has a valid account, the middleware 140 passes the information contained in the transfer request 300 to the network administrator 160, which stores the corresponding information and submits the transfer request 300 to the processor 180 for payment approval. Using that information, the processor 180 then polls the funding source 190 to determine whether the funds requested for transfer are available. The funding source 190 checks its memory to determine whether the funds in the user's account are sufficient to cover the requested transfer.

In some embodiments, the sender may have multiple accounts, or the sender may have linked the sender's account to a bank account and/or credit card. In such an embodiment, the sender can identify the account from which to transfer funds in the transfer request 300. If the requested account is a bank account or credit card, the funding source 190 will deduct the funds for transfer from that account by communicating with the appropriate clearing house (i.e. bank, ACH transfer, credit card processor, direct deposit, check deposit, etc.) via a communication channel.

If sufficient funds are not available, the processor 180 communicates the failed funds request to the network administrator 160, which purges the transfer request 300 information from its memory and communicates the denial to the middleware 140, which may optionally send a SMS message through the SMS Gateway 120 to the requesting user's mobile device.

If the funds are available, the funding source 190 determines whether the recipient is a user of the system. This determination is made in similar fashion to the validation of the sender's information. In other words, the funding source 190 compares information associated with the recipient (such as the recipient's mobile number) to records of registered users to determine whether there is a match. If so, the funding source 190 debits the requesting user's funds and generates a money transfer control (“MTC”) number. The MTC number is then transmitted to the processor 180, and is then transmitted to the network administrator 160. The network administrator 160 associates the MTC number with the transfer request 300 information and holds the appropriate funds.

Then the middleware 140 sends a SMS message through the SMS Gateway 120 to the recipient and requests conformation of receipt. Upon receipt, the recipient may respond with a confirmation via SMS transmission. If the recipient has multiple separate accounts, the recipient's confirmation may include a selection of which account the recipient wishes to receive the funds to. The confirmation is transmitted through the SMS Gateway 120 to the middleware 140, which sends a request to the network administrator 160 to release the funds to recipient. The network administrator 160 stores the request data and submits it to the processor 180. The processor 180 submits the request to the funding source 190, which debits the network administrator 160 account, credits the recipient's account and generates an MTC number. That MTC number is transmitted to the processor 180, which passes it along to the network administrator 160 and then the middleware 140, which communicates the funds transfer to the requesting user through the SMS Gateway 120. The funds are then transferred to the recipient's account, and are therefore available for use on the recipient's middleware 140 transaction card.

In an embodiment, it is contemplated that the system can accept transfers to recipients who are not registered users. In a scenario where the recipient is not a registered user, the funding source 190 debits the sender's funds and generates an MTC number. The MTC number is then transmitted to the processor 180, and is then transmitted to the network administrator 160. The network administrator 160 associates the MTC number with the transfer request 300 information and holds the appropriate funds. The middleware 140 then sends a SMS message through the SMS Gateway 120 to the recipient, wherein the SMS message includes a unique receipt code supplied by the middleware 140. The recipient then redeems the unique code at a retail kiosk 100.

More specifically, the recipient may take the unique code to a participating retail kiosk 100. The retail kiosk 100 receives the unique code from the recipient and requests verification and release of funds from the network administrator 160. The network administrator 160 stores the data received and associates the data with the MTC number. The network administrator 160 then communicates with the middleware 140 to verify the unique code. Because the middleware 140 supplied the unique code, the middleware 140 can also verify the authenticity of a unique code.

In the event that the middleware 140 determines that the unique code is not authentic, the middleware 140 communicates this denial to the network administrator 160. The network administrator 160 then purges the stored data from its memory and communicates the denial to the retail kiosk 100, which in turn optionally communicates the denial to the recipient.

As a security measure, in some embodiments it may be preferable not to send the denial via SMS Gateway 120 to the requesting user. Sending a SMS message indicating that the transfer was denied may prompt a fraudulent recipient to continue attempting to transfer funds, for example by continuing the guess at unique codes.

However, if the middleware 140 instead determines that the unique code is in fact authentic, it communicates this verification to the network administrator 160. The network administrator 160 submits the request to the processor 180, which submits the request to the funding source 190. The funding source 190 then debits the network administrator 160 account, credits the recipient's account, and generates an MTC number. Typically, the funding source 190 generates an MTC number each time it debits/credits an account.

The MTC number is then communicated from the funding source 190 to the network administrator 160 through the processor 180. The network administrator 160 communicates the transfer notice to the retail kiosk 100, which activates a new debit card or a new gift card with the appropriate funds and provides the debit/prepaid card with the loaded funds to the recipient. Instead of activating a debit card, prepaid card, or gift card, the retail kiosk 100 may dispense the funds to the designated recipient. In fact, the retail kiosk 100 may be an ATM machine for dispensing cash. The middleware 140 communicates a confirmation of the transfer to the recipient through the SMS Gateway 120.

Optionally, the middleware 140 may receive additional identifying information about the unregistered recipient, and associate that additional information with the new card. Such information may be sent to the middleware 140 from the retail kiosk 100, or an unregistered user may enter it directly to a website or similar network access system (i.e. a mobile phone application, etc.). As a result, the middleware 140 can create an account for the unregistered recipient, who can then receive funds without the need to go through a retail kiosk 100. Creating an account also allows the previously unregistered recipient to transfer funds to further recipients.

In an alternative embodiment, the user seeking to send funds may initiate a request to transfer funds to a recipient's debit card, prepaid card, or gift card through a website, or a similar network interface. In such an embodiment, the requesting user sends a transfer request 300 through a web interface (including, for example, a mobile phone application) to the middleware 140 via the internet. The format of such a web-based transfer request 300 may be similar or identical to the format of a transfer request 300 made via SMS transmission. That is to say the format of the transfer request 300 must contain information at least sufficient to identify the sender, the recipient, and the amount of funds to be transferred. Here too it may be preferable to identify the recipient by mobile phone number so that the system can easily reach the recipient by SMS transmission. However, it is understood that the recipient may also be identified and contacted via email address, or that the middleware 140 may contain reference information from which the middleware 140 can look up the recipient's contact information based on the recipient's name, account number, or other identifying information.

Regardless of whether the middleware 140 receives the transfer request 300 via SMS transmission or via web interface, the middleware 140 then proceeds to validate the transfer request 300 and passes it along to the network administrator 160. The network administrator 160 stores the corresponding information and submits the transfer request 300 to a processor 180 for payment approval. The processor 180 polls the funding source 190 to determine whether the funds requested for transfer are available. The processor 180 is able to poll the funding source 190 because the transfer request 300, which is passed along to the processor 180, includes information identifying the sender and the amount to be transferred. With this information, the processor 180 can make a software call to the funding source 190, which in turn performs a lookup of the funds available to the identified sender.

If the funds are not available, the processor 180 communicates the failed funds request to the network administrator 160, which purges the transfer request 300 information and communicates the denial to the middleware 140. The middleware 140 may send the denial back to the requesting sender through the web interface through which the sender initiated the transfer request 300, or the middleware 140 may notify the requesting sender of the denied transfer request 300 via SMS transmission, assuming the requesting sender has provided a mobile phone number to the middleware 140.

If the funds are available, the funding source 190 determines whether the recipient is a middleware 140 user. If so, the funding source 190 debits the requesting user's funds and generates an MTC number. The MTC number is then transmitted to the processor 180, and is then transmitted to the network administrator 160. The network administrator 160 associates the MTC number with the initial transfer request 300 information and holds the appropriate funds until the middleware 140 validates the transaction. Once the network administrator 160 is holding the appropriate funds, it notifies the middleware 140, which in turn sends a notification to the recipient. In this example, the recipient is given notification via SMS transmission, but it is understood that other forms of notification, including email or notification via web interface, are also contemplated.

In response, the recipient sends a confirmation back to the middleware 140. The confirmation is transmitted through the SMS Gateway 120 to the middleware 140. Once the middleware 140 receives the confirmation, and sends a request to the network administrator 160, which has been holding the funds. Having received the confirmation, the middleware 140 instructs the network administrator 160 to release the funds. The network administrator 160 stores the data relating to the request and submits it to the processor 180. The processor 180 submits the request to the funding source 190, which debits the network administrator 160 account, credits the recipient's account, and generates an MTC number, which is transmitted to the processor 180. The processor 180 passes it along to the network administrator 160 and then the middleware 140, which communicates the funds transfer to the requesting user through the SMS Gateway 120. The funds are then transferred to the recipient's debit card.

It is possible that the recipient is not a registered user. In such a situation, the procedure by which the system may hold the funds until the unregistered recipient registers an account is described above.

In yet another embodiment, the transfer of funds may occur between a sender at a first retail location and a recipient at a second retail location. FIGS. 7 & 8 provide an example of such an embodiment. In such an example, a user requesting a transfer uses a retail kiosk 100 to transfer funds to a recipient. The retail kiosk 100 sends the transfer request 300 information to the network administrator 160, which stores the transfer request 300 information and then passes it along to the processor 180, which submits the request to the funding source 190 for transfer approval.

If the funds are not available in the requesting user's account, a failed funds transfer notice is provided to the processor 180, which communicates it to the network administrator 160, which purges the stored data and communicates the denial to the retail kiosk 100, which informs the requesting user of the failed request.

On the other hand, if the funds are available in the requesting sender's account, the funding source 190 debits the sender account and proceeds with the transaction processing procedure already described above.

An additional security measure that may be incorporated by the system includes the use of a PIN code. In this embodiment, in order to receive funds, the recipient must enter the correct PIN code associated with a transaction before the release of funds to the recipient. The PIN code must be conveyed by the sender to the recipient outside the context of the present system. Thus, even if a transmission from the middleware 140 inadvertently reaches an unintended recipient, that unintended recipient will be unable to claim any funds because the unintended recipient will not know the required PIN code. In this embodiment, the PIN code is a four digit number, but it is understood that the system may be implemented using a longer or shorter PIN code, or a PIN code consisting of any combination of numbers, letters, and/or symbols.

In order for the system to release funds to a recipient only after the recipient correctly enters the PIN code, the system must first associate a PIN code with a transfer of funds. When a sender initiates a transfer request 300, the sender may include a PIN code in the transfer request 300 that is passed along to the middleware 140. The PIN code is then stored in the middleware 140's memory, where it is associated with the transfer request 300. In an alternative embodiment, the middleware 140 could generate the PIN code, associate the PIN code with the transfer request 300, and then transmit the PIN code back to the sender. In either embodiment, a PIN code is stored by the middleware 140 and associated with the transfer request 300. The sender must then convey the PIN code to the recipient using a medium other than this system. For example, the sender may tell the PIN code to the recipient during a telephone conversation, or through any other method of communication.

The middleware 140 then proceeds to pass the transfer request 300 along to the network administrator 160, and the transaction is processed in the manner already described above. The middleware 140 never sends the PIN code to the recipient, but in the final step the recipient is prompted to enter a PIN code before the funds are credited to the recipients account. The recipient may respond by entering the PIN code in a SMS transmission, by email, or by entering the PIN code into a web interface or retail kiosk 100. The PIN code entered by the recipient is transmitted to the middleware 140 (either via internet or via SMS Gateway 120). The middleware 140 compares the PIN code submitted by the recipient with the PIN code in its memory associated with the transfer request 300. If the middleware 140 determines that there is a match, then it has effectively validated that the recipient is the intended recipient. The funds are then released to the recipient's debit card in the manner already described above. If the PIN code does not match the PIN code associated with the transfer request 300, then the middleware 140 may send a notification to the recipient, or the middleware 140 may not send a notification, thereby discouraging a fraudulent recipient from making multiple attempts.

What is claimed is:

1. A computer system for facilitating a transfer of funds, comprising:
a processor in operable communication with a memory, the memory containing at least one account identifier; and
a communication port linking the processor to a communication portal and to a network server;
wherein the processor is capable of receiving a transfer request including an account identifier from the communication portal via the communication port, and the processor is programmed to forward the transfer request to the network server if the processor determines that the transfer request contains an account identifier matching an account identifier stored in the memory.

2. The computer system of claim 1, wherein the communication portal is a SMS Gateway.

3. The computer system of claim 1, wherein the communication portal is a web based interface.

4. The computer system of claim 1, wherein the communication portal is a retail kiosk.

5. The computer system of claim 1, wherein the account identifier is a mobile phone number.

6. A method for facilitating a transfer of funds, comprising the steps of:
receiving a transfer request via a communication channel, the transfer request containing an account identifier;
using a processor to compare the account identifier of the transfer request to an account identifier stored in a memory; and
sending the transfer request to a network server if the processor determines that the account identifier of the transfer request matches an account identifier stored in the memory.

7. The method of claim 6, wherein the communication channel is the internet.

8. The method of claim 6, wherein the communication channel is a private network.

9. A computer system for facilitating a transfer of funds, comprising:
a processor in operable communication with a memory;
a communication port linking the processor to a communication portal and to a network server;
wherein the processor is programmed to send a message to a user via the communication portal, receive a confirmation from the user via the communication portal, and send a message to the network server requesting a fund transfer upon receiving the confirmation.

10. The system of claim 9, wherein the message sent to a user via the communication portal includes a request for confirmation.

11. The system of claim 9, wherein the communication portal is a SMS Gateway.

12. The system of claim 9, wherein the communication portal is a web interface.
